(19) United States
(12) Patent Application Publication
(10) Pub. No.: US 2009/0110161 A1
(43) Pub. Date: Apr. 30, 2009

(54) DIGITAL TELEPHONE INTERFACE DEVICE

(76) Inventor: Steve Darrow, Monrovia, CA (US)

Correspondence Address: MARC E. HANKIN, ESQ., 11414 THURSTON CIRCLE, LOS ANGELES, CA, 90049, US

(21) Appl. No.: 11/925,695

(22) Filed: Oct. 26, 2007

(51) Int. Cl. H04M 3/00

(52) U.S. Cl. 379/93.05; 379/93.26

(57) ABSTRACT

Various embodiments of this invention are directed towards a digital telephone interface device for use with PBX systems. One or more embodiments of the invention augment the audio data transmitted between the digital telephone and PBX such that periodic beeps or inputted audio signals are added to the audio data transmission. One or more embodiments of the invention further allow analog audio signals to be extracted from the data signals for recording, monitoring, or other such purposes.

### FIELD OF INVENTION

Various embodiments of this invention relate, generally, to digital telephone systems; more particularly, to interface devices for digital telephone systems that allow audio signals such as beeps and analog audio to be inserted into telephone communications and allow the communications to be monitored or recorded by another device.

### BACKGROUND

In the art of telephony, Private Branch Exchanges (PBX's) are frequently used in order to allow a private business to operate multiple telephones with an automatic switchboard for use with multiple outside phone lines. Modern digital PBX systems, for example, allow multiple digital telephones to be connected to a common PBX. While such PBX systems provide an efficient and reliable means of connecting phones to each other and the public switched telephone network, because the transmissions between the telephones and the PBX are digital, digital PBX systems are not compatible with many analog based accessories for telephones.

For example, analog devices that allow telephone calls to be recorded or monitored and for beeps to be inserted over telephone calls are frequently used on analog telephone systems. Such devices operate, generally speaking, by operating as a tap that interfaces between the telephone and the wall jack. U.S. Pat. No. 4,446,335 to Lee et al., for example, discloses a telephone signal recording method and apparatus that operates by tapping an audio signal from the modular jack to which a telephone is connected. Thus, devices such as Lee's allow for operators to record or monitor analog telephone systems. These devices, however, are not compatible with digital PBX systems.

One device for monitoring telephone calls on a digital system is disclosed by U.S. Pat. No. 6,249,570 to Glowny et al., which discloses a system for monitoring a telephone switching system and recording data and audio related to telephone calls. Glowny's system includes a memory system and a processor that is programmed to identify telephone calls and to store information related to the calls such as caller, recipient of call, length of call, and other such information. While disclosing the application of these and other features on a digital telephone system, Glowny fails to disclose a system that is connected between a telephone and PBX in order to convert the digital information to analog signals that may be easily monitored or recorded.

Another such device is disclosed by U.S. Pat. No. 4,518,827 to Sagara. Sagara's device comprises an improved telephone answering machine that incorporates an analog to digital converter and a plurality of digital memory units in order to allow telephone calls to be recorded. Such a device, however, is unsuitable for monitoring calls on a digital PBX system because it operates on analog phone lines.

U.S. Pat. Nos. 6,038,676 and 6,038,037, both to Leung et al., disclose digital network interfaces for standard analog wire line fax equipment. Leung's interfaces operate, generally speaking, by facilitating an interface between analog fax systems and digital, wireless telecommunications services. The disclosed systems, however, do not allow analog signals to be monitored or inserted into a digital PBX system.

U.S. Pat. No. 6,608,894 to Armenta discloses a logging tap that provides for direct connection of a plurality of decoder units having a plurality of digital-to-analog converter inputs to a plurality of digital telephone signal lines. While Armenta discloses the use of a device at a type 66-block that functions as a logging tap for extracting phone signals to be supplied to a decoder unit, the patent fails to disclose the use of a discrete unit that is capable of extracting and converting the data for an individual telephone. What is more, Armenta fails to disclose the use of a device that further allows the users to insert audio, such as beeps, onto a phone line. Thus, Armenta's device is not usable in several applications wherein an operator desires to extract digital voice signals from a single telephone line and insert audio to the digital signal transmitted from the telephone to the PBX.

The DynaMetric TMP-636 Telephone Transmit Patch uses a method to retrieve audio from and send audio to digital telephones connected to a PBX by connecting to the handset. This technique does not however allow for use in the phone closet where the PBX is located, and requires the equipment to be connected to the telephone which can be objectionable to the users.

The DynaMetric TBR-1, TBR-10 and TBR-20 Telephone Beepers connect to digital telephones connected to a PBX to provide a beep to both parties. This technique does not however allow for use in the phone closet where the PBX is located, and requires the equipment to be connected to the telephone which can be objectionable to the users.

Thus, there remains a long felt need in the art for a telephone interface device that is connected between a telephone and a PBX and allows analog audio signals to be extracted from the connection and analog audio signals to be added to the digital connection.

### SUMMARY OF THE INVENTION

Various embodiments of the invention are directed towards overcoming the above shortcomings by disclosing a telephone interface device that is connected between a telephone and a PBX and allows analog audio signals to be extracted from and added to the digital signal, along with various other programmable functions.

One of the important functions performed by various embodiments of the invention is the insertion of analog audio signals onto the digital signal that is transmitted between the telephone and the PBX. For example, in various applications, it is desirable to have periodic beeps transmitted over the line such that both callers may hear the beeps. In other applications, for example, it is desirable to allow callers to listen to other audio presentations such as announcements or sales presentations. Various embodiments of the invention improve upon the prior art systems by allowing such analog audio signals to be inserted onto the digital signal transmitted between a telephone and PBX. Unlike prior art systems, the device remains compatible with digital PBX systems. Further, various embodiments of the invention allow these functions to be preformed without the complications of an interface at the 66-block. In this manner and unlike the prior art, the telephone operator may easily control these functions from the handset.

In the common manner in the art, data is transmitted between the telephone and the PBX in data packets that travel alternately from the PBX-to-telephone and telephone-to-PBX. Further, the DC power, supplied to the telephone from the PBX, is included with the transmission of data packets. In various embodiments of the invention, the device intercepts data packets as they are transmitted and, in turn, transmits modified data packets that reflect the audio changes requested by the operator. The DC power from the PBX is passed on to power the telephone.

In various embodiments of the invention, in order to minimize the time delay caused by the insertion of modified signals, all bits are retransmitted unmodified, with the exception of the voice audio bits, which are delayed by one packet time cycle. As each bit is inputted and interpreted by the device, the device generates a corresponding output bit. In this manner, with the exception of the small interpretation delay, the signals are not delayed, preventing de-synchronization of the received and transmitted signals.

In various embodiments of the invention, the voice audio portion of an inputted data packet is directed to an internal buffer memory. There, one or more of several operations are performed on the data: (1) the addition of an internal beep signal is added to the data signal; (2) an inputted audio signal is added to the data signal; and/or (3) audio signals are supplied in analog form to an output signal that may be supplied to a monitoring or recording system.

After one or more of the above operations is performed, the modified data is supplied to a buffer memory and transmitted with the next outgoing data packet. It should be noted that, in various embodiments of the invention, audio processing operations are performed on the input data signal such that the beep may be clearly heard both by the telephone operator and the listener on the other end of the phone line.

In various embodiments of the invention, volume adjustment controls are allowed for the transmitted beep and/or added external audio signal. In one embodiment of the invention, independent volume controls are allowed such that the telephone operator may reduce his or her volume while maintaining the consistently higher volume for the listener at the other end of the line.

In various embodiments of the invention, the device further includes an Ethernet jack, such as an RJ-45 IP protocol jack, such that the device may be connected to a personal computer, portable handheld device, or similar such device (collectively referred to as computers). The device, in turn, generates an HTML screen at the computer such that the operator may easily program and monitor a plurality of functions at the device. For example, some of the functions that may be programmed and/or monitored include: Beep Function: volume for each party and on/off for the beep function; Encoding Function: A-Law, μ-Law, or Auto; External Audio: on/off, telephone volume, and listener volume; Beep From a Call Logger: on/off, volume, or band pass filter; Special Line Record: on/off and combination selection; PBX Protocol Detect: Enabled or Manual; Alarms: Enabled/Disabled, reset alarms, or conditions; Status of Ports: No Connection/Connected; Remote Programming; Status Monitoring by LAN or Wireless LAN. Each of these computer-controlled features is discussed in further detail below.

Beep Functions: The device's beep functions are programmable at the computer. For example, the beep may be turned on and off and the volume of the beep may be independently controlled for both the telephone operator and the listener at the other end of the line.

Audio Output Volume: Similarly, the analog audio signal that is inserted onto the transmitted data packets may be independently controlled for the telephone operator and listener from the computer. Of course, alternatively, the volume at either or both ends of the phone line may altogether be shut down as well.

Special Line Record: Optionally, on multi-line phone systems, the device may be configured such that the device modifies only one specific phone line. For example, a company may designate a specific phone line to be constantly recorded and to transmit the beep signals.

Record Button Feature: The device may be configured such that, by pressing one of the programmable buttons on the telephone, the recording output is automatically enabled. In this manner, the device intercepts and interprets the data signals supplied by the telephone to the PBX in order to send the telephone conversation audio signal to an external recording device.

Beep from Call Logger: The device may optionally be configured to add to the phone line audio a beep that is generated by a call logger or call recorder. As in known in the art, call loggers commonly supply an audio signal, such as a periodic beep. In this configuration the periodic beep supplied by the call logger is added to the phone line such that the telephone operator and the listener may hear it.

Phone-PBX Protection: Because the highest priority of the telephone system manager is that the system is reliable and consistently working, the device includes a 4-way failsafe system. That is, because of the potential for interfering with the telephone system's operations, the device will automatically bypass all of its operations if any of the following four conditions are detected: (1) an internal detection of failure of the device's system software; (2) a timing fault detected by the timer connected to the device's microprocessor; (3) a fault detected by the hardware power supply voltage monitor indicating that system power supply voltages are out of tolerance; or (4) disconnection of power or a power supply failure. In this manner, the 4-way failsafe system serves to protect the connection between the PBX system and the telephone, even if the device should for any reason fail to operate properly.

USB Output Port: Optionally, the device may feature an additional USB port such that it may interface with a computer device and receive and transmit audio output signals to the computer. In this manner, a computer may be used to transmit audio signals to the device and the device may, in turn, supply to the computer audio signals, which may be recorded or monitored.

Status/Alarm LEDs: Various embodiments of the device may further feature one or more status or alarm LEDs to indicate to the operator the status of each channel: connected, active, disconnected, and/or audio presence. In this manner, the device status may be monitored by observing the LEDs.

Protocol Detection: In various embodiments of the invention, the device may automatically detect the PBX protocol being used and automatically adapt to the particular protocol. In several embodiments of the invention, this function is performed by, first, when being connected to the system, repeating all data packets until the time when it discerns the type of protocol being used. Then, once the protocol is detected, the device performs standard operations.

In summary, various embodiments of the invention disclose a device that may be connected between a digital telephone and a PBX such that analog audio signals may be added to or extracted from the digital signal and various operations may be performed to the transmissions.

### BRIEF DESCRIPTION OF THE DRAWING

FIG. 1 is a schematic diagram that illustrates the operation of the device in various embodiments of the invention.

### DETAILED DESCRIPTION OF THE DRAWING

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope of the invention. Various embodiments of the invention remain useable in tandem or combination of one another.

In the following description, certain terminology is used to describe certain features of one or more embodiments of the invention. For instance, “PBX” refers to any of the various “private branch exchanges” or telephone facilities that handle communications within an office, office building, or organization and that are connected to the public telephone network, including but not limited to Private and Circuit Switched PBX's, Hosted/Virtual PBX (Hosted and Circuit Switched PBX's), IP PBX (Private and Packet Switched PBX's), IP Centrex or Hosted/Virtual IP (Hosted and Packet Switched PBX's), Voice-over Internet Protocol (VoIP) PBX's and any further such PBX's known in the art; “telephone” refers to any of the various devices that connect to a PBX in order to allow voice communications; and “analog audio” refers to any of the various electronic audio signals that are continuously variable and non-quantized.

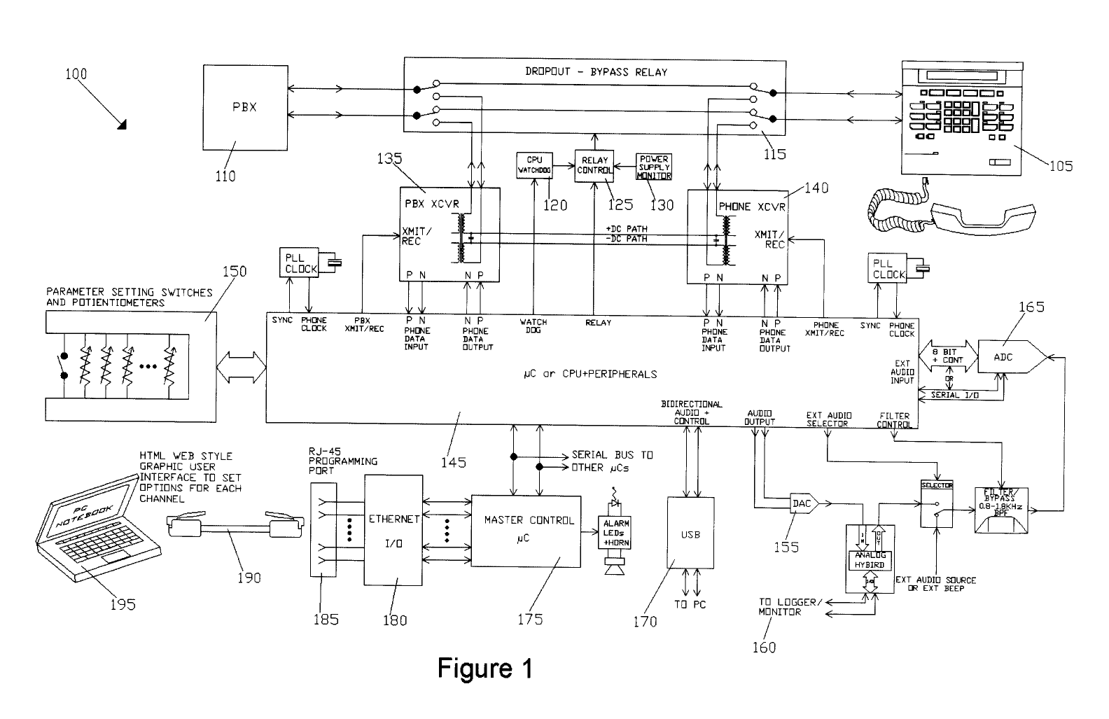

FIG. 1 is a schematic diagram that illustrates the operation of the device in various embodiments of the invention. A telephone and PBX system device 100 is illustrated with the various operations of the device illustrated schematically. As shown in the figure, the input and output of the telephone 105 are connected to the PBX 110 by the device 100. The failsafe system 115, 120, 125 & 130 of the device operates a series of relays 115 that override any device 100 operations in the event of a system failure. The failsafe system operates by receiving signals from a CPU monitor 120, a relay controller 125, and a power supply monitor 130; any of which can command the failsafe system 115 to override the device in the event of a system failure. The device's 100 main microprocessor is illustrated schematically by 145, which is connected to the PBX transceiver 135 and the telephone transceiver 140. The PBX transceiver 135 and telephone transceiver 140 serve to receive unmodified signals from the PBX and telephone, respectively, and to transmit the modified signals to the PBX and telephone, respectively. The main microprocessor 145 is also connected to a series of potentiometers and switches 150, which allow an operator to control functions of the device 100, such as, beep volume. A digital-to-analog converter 155 and an analog-to-digital converter 165 allow the device 100 to interface with a call logger 160 and, optionally, insert beeps transmitted by the call logger 160 onto the audio signal heard at the telephone 105 and at the listener at the other end of the line. In various embodiments of the invention, the device 100 further features a master control microprocessor 175 and an Ethernet input/output 180, which allow the device 100 to communicate with a computer 195 by a RJ-45 port 185 connected to an Ethernet cord 190.

What is claimed is:

1. A device that interfaces with a private branch exchange (PBX) and a digital telephone, comprising:
a first input, said first input configured to receive and transmit data signals to said PBX;
a second input, said second input configured to receive and transmit data signals to said digital telephone;
a first output, said first output configured to transmit analog audio data signals that are related to said data signals for recording, monitoring, or other such purposes; and
a microprocessor, said microprocessor configured to receive incoming data signals from said first input and from said second input and to augment said incoming data signals to include an audible beep on outgoing data signals.

2. A device that interfaces with a private branch exchange (PBX) and a digital telephone according to claim 1, wherein said microprocessor receives said incoming data signals and retransmits all data signals unmodified with the exception of audio data bits, which are augmented to include an audible beep on said outgoing data signals.

3. A device that interfaces with a private branch exchange (PBX) and a digital telephone according to claim 2, wherein said outgoing audio data signal is stored to a buffer memory and transmitted with the next outgoing data packet.

4. A device that interfaces with a private branch exchange (PBX) and a digital telephone according to claim 1, further comprising:
a third input, said third input configured to receive signals related to audio; and
said microprocessor is further configured to augment said audio data bits, which are further augmented to include an audible signal on said outgoing data signals that is related to the signal received from said third input.

5. A device that interfaces with a private branch exchange (PBX) and a digital telephone according to claim 1, further comprising: a digital audio processor configured to augment said audio data bits such that said audible beep may be clearly heard by all parties on the phone line.

6. A device that interfaces with a private branch exchange (PBX) and a digital telephone according to claim 1, wherein said device further includes controls such that an operator may independently regulate the volume of said audible beep at the operator's end of the phone line and at the listener's end of the phone line.

7. A device that interfaces with a private branch exchange (PBX) and a digital telephone according to claim 1, wherein said device further includes controls such that an operator may independently regulate the volume of said audible signal received at said third input at the operator's end of the phone line and at the listener's end of the phone line.

8. A device that interfaces with a private branch exchange (PBX) and a digital telephone according to claim 1, further comprising:
an input/output bus configured to connect said device to a computer such that said computer may control one or more functions on said device selected from the group of: volume of said audible beep for each party, on/off for said audible beep, selection of encoding type; volume of said audio signal received from said third input, on/off of said audio signal received from said third input; volume of a beep received from a call logger, on/off of a beep received from a call logger; special line record, PBX protocol, port status, and remote programming.

9. A device that interfaces with a private branch exchange (PBX) and a digital telephone according to claim 8 wherein the input/output bus comprises an Ethernet jack.

10. A device that interfaces with a private branch exchange (PBX) and a digital telephone according to claim 8, wherein the input/output bus comprises a bus selected from the following group: wireless local area network (LAN) bus, wireless bluetooth bus, or universal serial bus (USB).

11. A device that interfaces with a private branch exchange (PBX) and a digital telephone according to claim 8, wherein said computer comprises a computer selected from the following group: personal computer, laptop personal computer, personal data assistant, workstation computer, or tablet computer.

12. A device that interfaces with a private branch exchange (PBX) and a digital telephone according to claim 1 further comprising a failsafe mechanism, said failsafe mechanism configured such that said device will automatically bypass all of its operations if any of the following four conditions are detected: (1) an internal detection of failure by said device's system software; (2) a timing fault detected by the timer connected to said microprocessor; (3) a fault detected by a hardware power supply voltage monitor indicating that said device is extracting an unusual amount of power; or (4) disconnection of power or a power supply failure.

13. A device that interfaces with a private branch exchange (PBX) and a digital telephone according to claim 4, wherein said third input comprises a ⅛″ audio jack.

14. A device that interfaces with a private branch exchange (PBX) and a digital telephone according to claim 4, wherein said third input comprises a universal serial bus (USB).

15. A device that interfaces with a private branch exchange (PBX) and a digital telephone according to claim 1, further comprising a plurality of status LEDs, said status LEDs being configured to indicate the status of said device.

16. A device that interfaces with a private branch exchange (PBX) and a digital telephone according to claim 1, wherein said device automatically detects a protocol of said PBX and said digital telephone.

17. A device that interfaces with a private branch exchange (PBX) and a digital telephone, comprising:
a first input, said first input configured to receive and transmit data signals to said PBX;
a second input, said second input configured to receive and transmit data signals to said digital telephone;
a third input, said third input configured to receive signals related to audio;
a first output, said first output configured to transmit analog audio signals that are related to said data signals for recording, monitoring, or other such purposes;
an input/output bus configured to connect said device to a computer such that said computer may control one or more functions on said device selected from the group of: volume of said audible beep for each party, on/off for said audible beep, selection of encoding type; volume of said audio signal received from said third input, on/off of said audio signal received from said third input; volume of a beep received from a call logger, on/off of a beep received from a call logger; special line record, PBX protocol, port status, and remote programming;
a microprocessor, said microprocessor configured to receive incoming data signals from said first input, said second input, and from said third input and to augment said incoming data signals to include an audible beep and said signals related to audio from said third input on outgoing data signals.

18. A device that interfaces with a private branch exchange (PBX) and a digital telephone according to claim 17, wherein said microprocessor receives said incoming data signals and retransmits all data signals unmodified with the exception of audio data bits, which are augmented to include an audible beep on said outgoing data signals.

19. A device that interfaces with a private branch exchange (PBX) and a digital telephone according to claim 17, further comprising a digital audio processor configured to augment said audio data bits such that said audible beep may be clearly heard by all parties on the phone line.

20. A device that interfaces with a private branch exchange (PBX) and a digital telephone according to claim 17, wherein said device further includes controls such that an operator may independently regulate the volume of said audible beep and said signals related to audio from said third input at the operator's end of the phone line and at the listener's end of the phone line.

21. A device that interfaces with a private branch exchange (PBX) and a digital telephone according to claim 17, further comprising a failsafe mechanism, said failsafe mechanism configured such that said device will automatically bypass all of its operations if any of the following four conditions are detected: (1) an internal detection of failure by said device's system software; (2) a timing fault detected by the timer connected to said microprocessor; (3) a fault detected by a hardware power supply voltage monitor indicating that the device is extracting an unusual amount of power; or (4) disconnection of power or a power supply failure.

22. A device that interfaces with a private branch exchange (PBX) and a digital telephone according to claim 17, further comprising a plurality of status LEDs, said status LEDs being configured to indicate the status of said device.

23. A device that interfaces with a private branch exchange (PBX) and a digital telephone according to claim 17, wherein said device automatically detects the protocol of said PBX and said digital telephone.

24. A device that interfaces with a private branch exchange (PBX) and a digital telephone, comprising:
a first input, said first input configured to receive and transmit data signals to said PBX;
a second input, said second input configured to receive and transmit data signals to said digital telephone;
a third input, said third input configured to receive signals related to audio;
a first output, said first output configured to transmit analog audio signals that are related to said data signals for recording, monitoring, or other such purposes;
an input/output bus configured to connect said device to a computer such that said computer may control one or more functions on said device selected from the group of: volume of said audible beep for each party, on/off for said audible beep, selection of encoding type; volume of said audio signal received from said third input, on/off of said audio signal received from said third input; volume of a beep received from a call logger, on/off of a beep received from a call logger; special line record, PBX protocol, port status, and remote programming;
said input/output bus comprising one of the following input/output busses selected from the following: an Ethernet jack, a USB bus, a wireless LAN bus, or a wireless bluetooth bus;
a failsafe mechanism, said failsafe mechanism configured such that said device will automatically bypass all of its operations if any of the following four conditions are detected: (1) an internal detection of failure by said device's system software; (2) a timing fault detected by the timer connected to said microprocessor; (3) a fault detected by a hardware power supply voltage monitor indicating that system is extracting an unusual amount of power; or (4) disconnection of power or a power supply failure;
a volume controls system, said volume control system configured such that an operator may independently regulate the volume of said audible beep and said audible signal received at said third input at the operator's end of the phone line and at the listener's end of the phone line;
a digital audio processor configured to augment said audio data bits such that said audible beep may be clearly heard by all parties on the phone line;
a microprocessor, said microprocessor configured to receive incoming data signals from said first input, said second input, and from said third input and to augment said incoming data signals to include an audible beep and said signals related to audio from said third input on outgoing data signals, said microprocessor receiving said incoming data signals and retransmitting all data signals unmodified with the exception of audio data bits, which are augmented to include an audible beep on said outgoing data signals.
